(19) United States
(12) Patent Application Publication
(10) Pub. No.: US 2009/0314372 A1
(43) Pub. Date: Dec. 24, 2009

(54) FLUID FLOW REGULATING DEVICE

(76) Inventors: Stephen J. Ruskewicz, Kensington, CA (US); Justin D. Muratore, Berkeley, CA (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/373,812

(22) PCT Filed: Aug. 1, 2007
(86) PCT No.: PCT/US07/17292

§ 371 Date: Aug. 28, 2009

Related U.S. Application Data
(60) Provisional application No. 60/821,010, filed on Aug. 1, 2006.

(51) Int. Cl. G05D 7/01

(52) U.S. Cl. 138/46

(57) ABSTRACT

A fluid flow regulating mechanism designed particularly for use in connection with aerosolized drug delivery devices is disclosed. The mechanism includes a housing, planar elastic element, regulating element and positioning component. The elements of the device are configured in a manner such that a flow channel through the housing is opened or closed depending on the flow rate of fluid through a flow channel.

### FIELD OF THE INVENTION

The present invention relates generally to a device which regulates the flow of fluid such as air and more particularly to such a device as used for pulmonary drug delivery.

### BACKGROUND OF THE INVENTION

Inhalation devices for delivery of therapeutic substances to the respiratory tract of a user are now in common use. Currently available methods of generating and delivering drug formulations to the respiratory tract include metered-dose inhalers, dry powder inhalers and nebulizers. The effectiveness of such devices is limited in part by the ability to coordinate and to limit inhalation flow. Lack of control of inhalation initiation and velocity can result in deposition of formulation in areas of the respiratory tract, such as the mouth or the throat, which wastes formulation and reduces the effective concentration of formulation in the targeted portion of the respiratory tract for systemic circulation. Ideally, the formulation should be released early in the inhalation maneuver to maximize the inhalation volume available to deposit the drug in the lung, and delivered at an inhalation velocity range such that particles of formulation are entrained in the breath and delivered into the desired portion of the respiratory tract. Devices which do not coordinate the inhalation maneuver with the generation of formulation aerosol, and limit inhalation velocity, are particularly error prone. In such devices, users frequently inhale too rapidly to effectively transport the formulation to the targeted regions of the lung. Increasing the dose cannot always compensate for problems associated with inefficient administration of a drug, as an accidental excessive dose of a therapeutic agent may have severe negative consequences.

Various drug inhalation devices have been developed in which the control of inhalation velocity is left to the individual user, and can vary with the user's inspiratory effort. Such devices do not provide a means for limiting inspiratory flow velocity or triggering a device when a desired velocity threshold is achieved.

A hand-held, portable breath actuated device is described in U.S. Pat. No. 5,941,240. In this device, the user inhales air through an inspiratory flow path. When the inspiratory flow meets a threshold of a preprogrammed criterion, a microprocessor sends a signal to an indicating electrical mechanism, which in turn notifies the user the allowable range of inspiratory flow rate has been exceeded, and the flow velocity is now too high for efficient drug delivery.

The present invention addresses the need in the art for a simple, yet effective means of coordinating and limiting the inspiratory flow rate and velocity largely independent of the inspiratory effort of the user, and provides related advantages as well, such as the ability to trigger the device.

### SUMMARY OF THE INVENTION

A fluid flow regulating mechanism designed particularly for use in connection with aerosolized drug delivery devices is disclosed. The mechanism includes a housing, planar elastic element, regulating element and positioning component. The elements of the device are configured in a manner such that a flow channel through the housing is opened or variably closed depending on the flow rate of fluid such as air, aerosolized medication and the like through a flow channel.

The present invention provides a mechanism for initiating fluid flow and for limiting fluid flow velocity by rapidly increasing resistance to flow, after the fluid flow velocity has exceeded a desired threshold.

The fluid flow velocity limiting means can be operatively connected to a dispensing mechanism and creates a triggering signal, whereby a transmitted signal causes a dispensing mechanism to release a volume of formulation.

The mechanism may be used in combination with a pharmaceutical inhaler such as an MDI (metered dose inhaler), DPI (dry powder inhaler) and the like, for repeatedly administering a precise dosage of a pharmaceutical agent to the respiratory system of a subject or patient. The device can be used with devices of the type taught in U.S. Pat. No. 6,014,969. The mechanism is simple, and may be disposable i.e. used until the medication is used up and then replaced with a new device. Accordingly, in some embodiments, the invention provides a device for delivering an aerosolized formulation to an individual, wherein the device comprises a fluid flow limiting mechanism as described herein. The aerosolization devices of the invention are advantageous in that aerosol is not released below a pre-set threshold inspiratory flow rate.

In some embodiments, a triggering mechanism is configured to further provide for regulation of fluid flow rates through the mechanism. When the triggering mechanism is used in combination with an inhaler, the triggering mechanism not only controls release of formulation, but also provides greater regulation of airflow.

One aspect of the invention is a device for regulating the release and airflow of a metered dose inhaler.

Another aspect of the invention is a device for administering a metered dose of formulation, wherein said device is regulated to release the formulation over a certain range of air velocities and thereby provide for repeatability of dosing to a patient.

An aspect of the invention is a flow limiting and trigger mechanism for use in conjunction with an aerosol delivery device, wherein the trigger mechanism senses and reacts to a predetermined velocity of fluid flowing through the mechanism.

The trigger mechanism of the invention provides a simple, yet effective means for actuating an operably linked aerosolization device in response to a user's inspiratory effort.

An aspect of the invention is a fluid flow regulating mechanism by itself or in combination with a pulmonary drug delivery device which mechanism comprises

a) a housing, having proximal and distal ends and inlet and outlet orifices respectfully defining a flow channel;

b) an essentially planar elastic element with linear deflection properties disposed within said housing and flow channel, said elastic element comprising proximal and distal ends, wherein said elastic element proximal end is anchored to said housing.

c) a regulating element on the distal end of said elastic element that can partially occlude said flow channel in response to air velocity around said elastic element.

d) a positioning component which abuts said elastic element distal end, for positioning said elastic element near the distal end of said housing, wherein said positioning component prevents said elastic element from moving to block the flow channel until air velocity passing over said elastic element exceeds a predetermined threshold.

Another aspect of the invention is such a mechanism by itself or in combination with a pulmonary drug delivery device which further comprises:

a flow coordination component comprising a linkage component, wherein said elastic element and said regulating element are restrained in a fully occluded position thereby preventing inhalation.

Still another aspect of the invention is a mechanism as described above by itself or in combination with a pulmonary drug delivery device which still further comprises:

a drug delivery device trigger mechanism connected to the linkage component.

Still yet another aspect of the invention is a mechanism as described above alone or in combination with a pulmonary drug delivery device which further comprises:

a trigger signal component which sends a signal when the linkage component actuates the trigger mechanism.

Another aspect of the invention is a mechanism as described above or alone or in combination with a pulmonary drug delivery device wherein the housing, elastic element, regulating element and positioning component are configured in such a way that passage of air having sufficient velocity through said flow channel, exceeding a predetermined threshold, deflects said elastic element and regulating element toward said housing outlet orifice, thereby actuating said trigger signal means.

Another aspect of the invention is a method of intrapulmonary drug delivery wherein a patient uses a pulmonary drug delivery device having a fluid flow regulating mechanism as described herein in the device to thereby improve the repeatability of dosing when the patient repeatedly uses the drug delivery device for repeated doses over a period of time.

These and other objects, advantages, and features of the invention will become apparent to those persons skilled in the art upon reading the details of the invention, as more fully described below.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 is a perspective view of an embodiment of a flow regulating device of the invention in an open position.

FIG. 2 is a perspective view of a flow regulation device of the invention in a closed position.

FIG. 3 is a perspective view of a rate valve component of the flow regulating device of the invention.

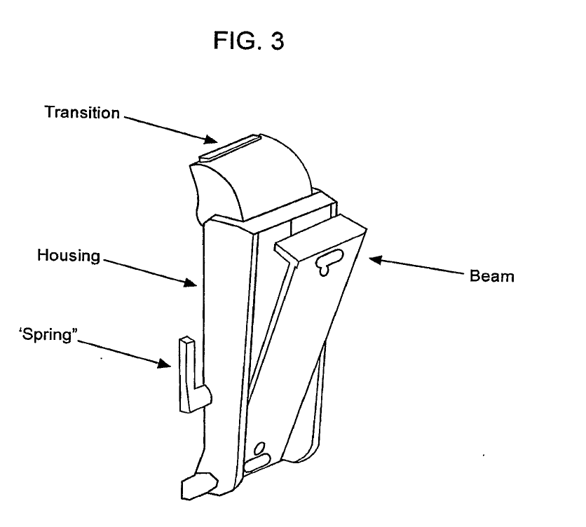

FIG. 4 is a perspective view of an embodiment of the rate valve component of the invention.

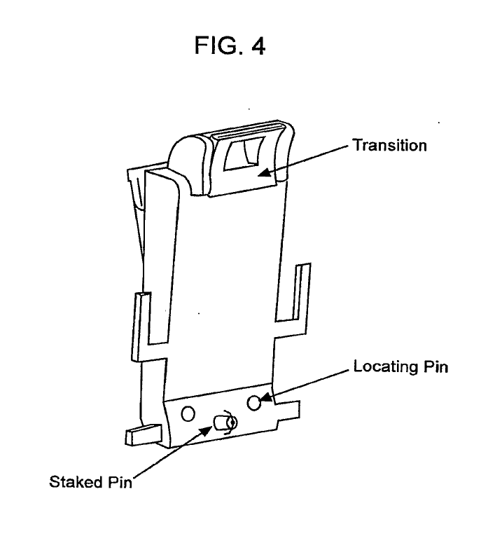

FIG. 5 is a perspective view of a rate valve component of the invention.

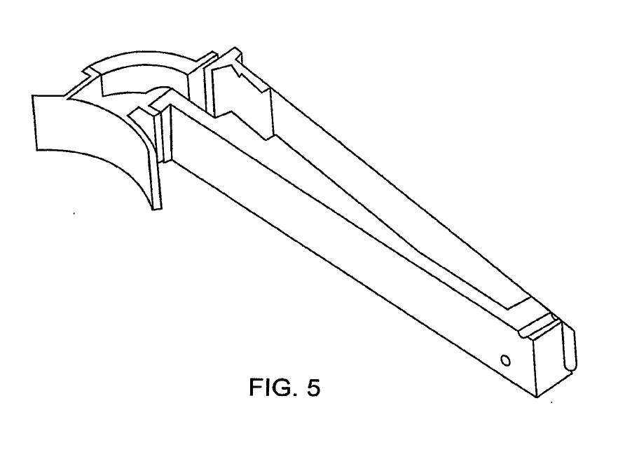

FIG. 6 is a graph showing results obtained with an embodiment of the invention.

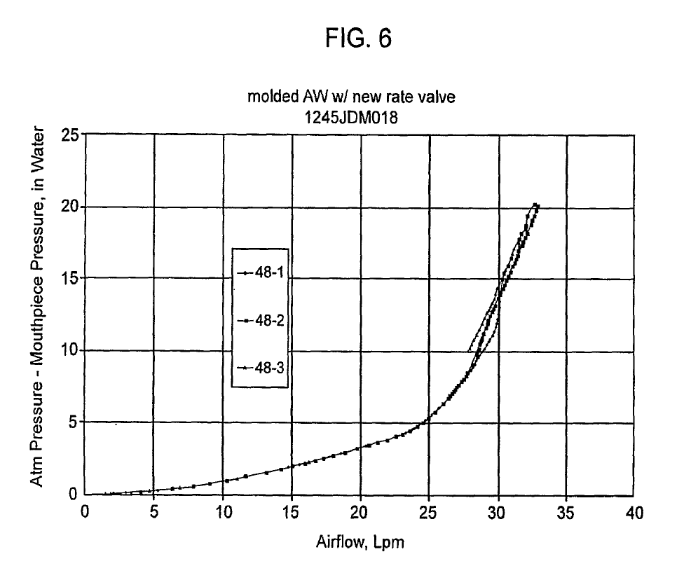

### DETAILED DESCRIPTION OF THE INVENTION

Before the present device and method embodiments of the invention are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supercedes any disclosure of an incorporated publication to the extent there is a contradiction.

It must be noted that as used herein and in the appended claims, the singular forms “a”, “an”, and “the” include plural referents unless the context clearly dictates otherwise. Thus, for example, reference to “a channel” includes a plurality of such channels and reference to “the element” includes reference to one or more elements and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### DEFINITIONS

“Fluid” includes liquids and gases. For example, when the fluid flow is induced by inspiration of air.

“Trigger flow rate” refers to a fluid flow rate at which a triggering mechanism can be configured to actuate the trigger signal means. For example, the trigger flow rate can be when the airflow rate is between about 0.1 to 2.0 liters per second, or a narrower range within this range, e.g., about 0.1 to about 0.3, about 0.2 to about 0.5, about 0.1 to about 0.5, about 0.5 to about 0.75, about 0.75 to about 1.0, about 0.6 to about 0.8, about 1.0 to about 1.25, about 1.2 to about 1.5, about 1.4 to about 1.6, about 1.5 to about 1.75, about 1.6 to about 1.8, about 1.75 to about 2.0, about 1.8 to about 2.0 liters per second. This airflow rate is referred to as the “trigger flow rate.” In some embodiments, the trigger flow rate is from about 0.66 to about 0.83 liters per second. In other embodiments, the trigger flow rate is from about 0.33 to about 0.4 liters per second.

“Inspiratory flow rate”, as used herein, refers to a value of airflow rate measured, calculated, and/or determined based on the speed of the air passing a given point in a measuring device assuming atmospheric pressure .+−.5% and a temperature in the range of about 10° C. to about 40° C. The pre-determined threshold velocity, V_{L}, can be set by varying certain parameters, as explained below. V_{L} can be varied, as desired, depending on a variety of factors, such as the age and size of the user, the physical state of the user, and the like. For example, V_{L} might be set to a lower value for a user with reduced lung function, as compared to a user who has normal lung capacity. Reduced lung capacity can result from a variety of conditions, including, but not limited to, asthma, pneumonia, emphysema, cystic fibrosis, smoke inhalation damage, and the like. Reduced lung capacity may also be a characteristic of immature lungs, e.g., of an infant born prematurely.

In addition, the mechanism can be configured such that a maximum fluid velocity, V_{H}, is set. V_{H} can be set in various ways, including, e.g., providing one or more vents in a sidewall of a distal portion of the housing.

Fluid Velocity Regulating Mechanism

The present invention provides a fluid velocity regulation mechanism which is sensitive to the flow rate of a fluid which passes through a fluid channel in the mechanism. By varying parameters of the regulating mechanism components, the regulating mechanism is adapted to perform one or more of the following functions:

(1) initiate fluid flow through a device by opening a passage which is under manual control;

(2) detect, and optionally measure, a fluid flow rate;

(3) regulate fluid flow through the mechanism. The regulating mechanism is particularly suited for use in an inhalation device, where the measured fluid flow is airflow inspired by the user of the device; and

(4) actuate a trigger signal in a triggering mechanism when the fluid flow rate is above a predetermined minimum value, V_{L},

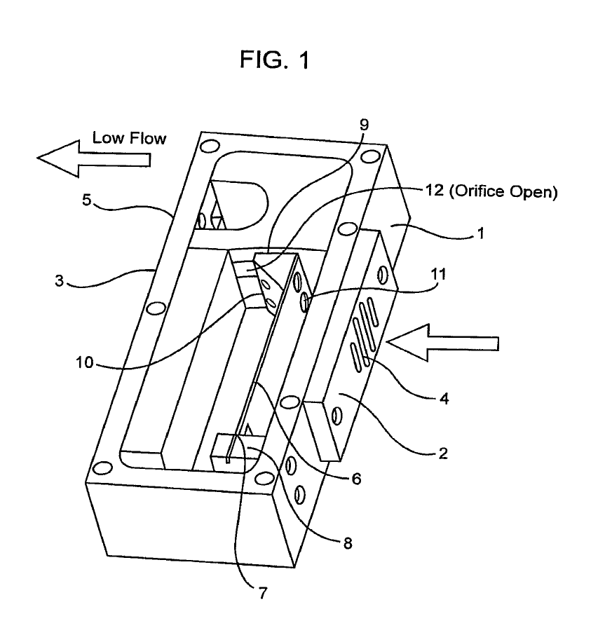

The fluid velocity regulating mechanism (FIG. 1) of the invention generally comprises: (1) a housing 1, having proximal end 2 and distal end 3 and inlet 4 and outlet orifice 5 located on the proximal and distal ends respectfully forming a flow channel; (2) a planar elastic element 6 disposed within the housing 1, the planar elastic element 6 having a proximal end 7 which is anchored in a preloaded position to the housing component 8, and an elastically moveable distal end 9 which carries a regulating element 10. The planar elastic element 6 can deflect perpendicular to the flow through the outlet orifice in response to fluid flow through the housing from the inlet to the outlet orifices. (3) a regulating element 10 positioned on the distal end of the planar elastic element, which can variably occlude the housing outlet orifice 5 proportional to the deflection of the planar elastic element 6 after it moves from an initial preloaded position in response to fluid velocity through the channel exceeding a predetermined threshold; (4) optionally, a trigger signal means 11, wherein the passage of air having sufficient velocity (V_{L}) through the housing 1 causes movement of the planar elastic element 6 from its initial preloaded position, resulting in actuation of the trigger signal means 11. (5) optionally, a flow initiating means comprised of a linkage means controlled by the operator, that restrains the regulating element in a position that fully occludes the housing outlet orifice preventing flow. At a signal from the operator, the mechanism releases the regulating element allowing the element to move to its preloaded position thereby opening the housing outlet orifice 12 and initiating flow in response to operator inhalation.

When used in conjunction with an inhalation device which comprises a dispensing mechanism operatively connected to the trigger signal means, the trigger signal means transmits a signal to the dispensing mechanism, causing release of a volume of formulation.

Method of Intrapulmonary Drug Delivery

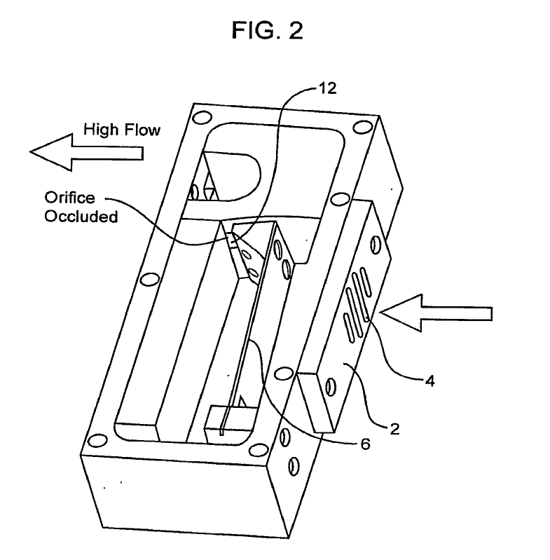

A method of the invention involves the intrapulmonary delivery of drugs to the patient. Using the device as described herein the patient inhales air through the inlet 4. That air flows against the elastic element 6. This causes movement of the elastic element 6 so as to close or partially close the orifice 12. Thus, the orifice 12 can be open as in FIG. 1 or partially closed as in FIG. 2 or closed completely so as to block flow out of the outlet orifice 5. Thus, the elastic element 6 detects the correct flow of air through the opening and based on the degree of elasticity of the element 6 the flow rate can be regulated so as to prevent flow through the device. The flow can be regulated to any desired range and the range can be preset so as to correspond to the particular type of drug and the particular type of patient being treated.

Regulating Mechanism Dimensions and Configurations

In general, the dimensions of the regulating mechanism (e.g., overall size of housing interior; dimensions of the fluid channel; size and shape of planar elastic element; dimensions of inlet and outlet orifices; presence, etc.) can be varied as required or desired, and will vary according to a variety of factors (e.g., the dimensions of the inhalation device, desired flow rate, desired maximum flow rate, etc.).

The components of the regulating mechanism, such as the housing, the planar elastic element, and the regulating means, are generally rectangular. However, the regulating mechanism components need not be rectangular. For example, if desired, any of the above components may be ellipsoidal, rectangular, square, or may take the form of a regular prism, for example a triangular, rectangular, pentagonal prism, and the like. In fact, the device need not possess any axial symmetry, as long as the planar elastic element is free to deflect in response to airflow through the housing, and as long as the fluid flow is directed through the fluid channel (e.g., substantially all of the fluid flows through the fluid channel). Additionally, it is not necessary for the device to be straight. For example, the device may be curved along an arc.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A fluid flow regulating mechanism, comprising:
a) a housing, having proximal and distal ends and inlet and outlet orifices respectfully defining a flow channel;
b) an essentially planar elastic element disposed within said housing and flow channel, said elastic element comprising proximal and distal ends, wherein said elastic element proximal end is anchored to said housing;
c) a regulating element on the distal end of said elastic element that can occlude said flow channel by deflection perpendicular to the flow through the outlet orifice in response to air velocity around said elastic element;
d) a positioning component which abuts said elastic element distal end, for positioning said elastic element near the distal end of said housing, wherein said positioning component prevents said elastic element from moving to block the flow channel until air velocity passing over said elastic element exceeds a predetermined threshold.

2. The mechanism of claim 1, further comprising:
a flow coordination component comprising a linkage component, wherein said elastic element and said regulating element are restrained in a fully occluded position thereby preventing inhalation.

3. The mechanism of claim 1, further comprising:
a drug delivery device trigger mechanism connected to the linkage component.

4. The mechanism of claim 3, further comprising:
a trigger signal component which sends a signal when the linkage component actuates the trigger mechanism.

5. The mechanism of claim 4, wherein the housing, elastic element, regulating element and positioning component are configured in such a way that passage of air having sufficient velocity through said flow channel, exceeding a predetermined threshold, deflects said elastic element and regulating element toward said housing outlet orifice, thereby actuating said trigger signal means.

6. A method for intrapulmonary drug delivery of a drug to a patient, comprising the steps of:
inhaling air through an opening;
detecting the rate of flow of the air through the opening;
regulating the rate of flow through the opening within a desired range; and
actuating a trigger signal to release an aerosolized formulation comprising a pharmaceutically active drug and allowing the aerosol to flow through the opening to a patient when the regulated flow rate is within a desired range.

7. The method as claimed in claim 6, wherein the air is inhaled over a substantially planar elastic element disposed within a housing and flow channel wherein the elastic element comprises a proximal and distal end, and wherein the elastic element proximal end is anchored to the housing.

8. The method as claimed in claim 7, wherein the elastic element moves within the housing in order to allow for and occlude flow of air through the housing.

9. The method as claimed in claim 8, wherein the elasticity of the elastic element is preset so as to variably occlude flow through the housing based on a target area of the patient's lung.
